(19) United States
(12) Patent Application Publication
(10) Pub. No.: US 2009/0287552 A1
(43) Pub. Date: Nov. 19, 2009

(54) System and method for playing sweepstakes games

(76) Inventors: Charles Shepherd, Dacula, GA (US); Anil Sonowane, Alpharetta, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/152,413

(22) Filed: May 13, 2008

(51) Int. Cl. G06Q 30/00

(52) U.S. Cl. 705/14.1

(57) ABSTRACT

Systems and methods for promoting a business with sweepstakes games and for playing sweepstakes games that allows a user to access or consume computer-based services while simultaneously playing sweepstakes games.

### TECHNICAL FIELD

The present invention relates generally to business methods and computer systems, and, more particularly, to systems and methods for promoting a business with sweepstakes games and for playing sweepstakes games.

### BACKGROUND OF THE INVENTION

Sweepstakes of all sorts have long been employed as entertainment, and as a means to promote businesses or to otherwise motivate individuals. For example, businesses may offer free sweepstakes entries to encourage potential customers to purchase goods and/or services by distributing the entries to visitors of a retail location, by providing the sweepstakes only upon purchase of goods and/or services, or the like.

Such sweepstakes range from lotteries, wherein no player input may be needed or may be permitted, to games whose outcomes depend on player skill. While sweepstakes that require little or no input, such as merely selecting lottery numbers or the like, may not unduly distract a player and are typically completed quickly, games that depend on player skill have the disadvantage of becoming the player's main or sole focus or interest, and can last for prolonged periods of time. Such interactive and distracting sweepstakes may be effectively used by businesses to promote goods or services where no further involvement of the customer is contemplated; particularly this is true for the sale of goods, where after the sale is completed the customer may leave or where the customer plays a passive role in the delivery of the service, such as for lawn care service or the like.

For businesses where ongoing customer participation is necessary or beneficial for success, such as where the customer is charged per use, per time increment, or the like, sweepstakes that require less involvement, and are therefore less distracting, may be preferred because the customer is then free to consume greater amounts of the service. For example, in an Internet cafe scenario, where a customer pays for service by the minute or other time increment, any time that the customer spends playing a promotional sweepstakes game is time that the customer may choose to not use service, or may not be able to use the service. Thus, during the time that the customer plays the promotional game, the business is not generating revenue. In such a scenario, the distracting nature of such sweepstakes games that require substantial player participation makes them unsuitable for use as a promotional tool due to the adverse impact on revenue.

Nonetheless, such sweepstakes games that require substantial player participation have the important advantage of being extremely effective in encouraging sales because players typically enjoy the sweepstakes games a great deal, possibly because they perceive that their participation increases their chance of winning the sweepstakes, and will, therefore, consume greater amounts of goods and/or services in order to gain access to the sweepstakes games. Thus, service businesses encounter the dilemma of choosing between sweepstakes games that effectively attract customers but which distract the customers from using the services, and sweepstakes games that are less effective at attracting customers but which do not interfere with use of the business's services. Thus, it is clear that there is an unmet need for a system and method for playing sweepstakes games that allow a player to access and/or consume business services while simultaneously allowing the player to play sweepstakes games, including those which involve player participation.

### BRIEF SUMMARY OF THE INVENTION

Briefly described, in a preferred embodiment, the system and method of the present disclosure overcome the above-mentioned disadvantages and meet the recognized need for such a system and method by providing a method of promoting goods and/or services wherein one or more sweepstakes game entry(ies) is(are) associated with a customer upon purchase of goods and/or services. The customer may then use one or more sweepstakes game entry(ies) to play a sweepstakes game. The system preferably allows the user to utilize the service while playing the sweepstakes game.

More specifically, a customer may utilize a terminal to access one or more sweepstakes game, wherein a display and means for inputting player selections and/or commands are provided. The sweepstakes game preferably utilizes a first portion of the display for displaying the game, and a second portion of the display is preferably utilized by a computer program product not associated with the sweepstakes game. The computer program product preferably automatically utilizes the service, such as according to the customer's preferences, and displays information or the like obtained from, or derived from, the service. For example, where the service is the provision of Internet access, the computer program product may locate and retrieve news headlines or the like from one or more source via the Internet for display in the second portion of the display.

Accordingly, one feature and advantage of the present system and method is the ability to allow promotion of goods and/or service via sweepstakes games involving player participation while simultaneously allowing automatic use of the service.

Another feature and advantage of the present system and method is the ability to increase the effectiveness of promotional sweepstakes for use in promoting services that require customer participation.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a diagram of a system for providing computer-based services;

FIG. 2 is an illustration of a display of the system; and

FIG. 3 is flowchart illustrating a method of use of the system of FIG. 1.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the system and method of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

In that form of the preferred embodiment of the present system and method chosen for purposes of illustration, FIG. 1 shows system 100 including user terminals 111-116 and management terminal 120 connected via network 130. Each of users U1-U6 is preferably a customer of a business offering a service, wherein user terminals 111-116 provide access to such service and wherein user terminals 111-116 may be formed as personal computers including a display, such as a touch-screen display. System 100 preferably includes a respective user account associated with each of users U1-U6 containing information pertaining to a customer account for the service. Management terminal 120 is preferably operable to maintain and update such user accounts based on use of system 100. Particularly, management terminal 120 is preferably operable to monitor and control network 130 and each of user terminals 111-116.

The service is preferably promoted via a promotional sweepstakes including at least one sweepstakes game. Entries usable to play a sweepstakes game may be assigned to a user account. For example, a number of entries may be associated with a user's account by management terminal 120 by incrementing the value of a field of a database stored on a storage medium of system 100. The number of entries may preferably correspond directly to a value of goods and/or services purchased. Management computer 120 may preferably be operable to allow a user to access a selected sweepstakes game according to the number of entries associated with the user's account, such as by a comparison or the value of the database field to a predetermined threshold, such as zero. When the user accesses a sweepstakes game, management computer 120 preferably decrements the value of the database field by a number of sweepstakes entries used, whereby an accurate accounting of the sweepstakes entries may be maintained.

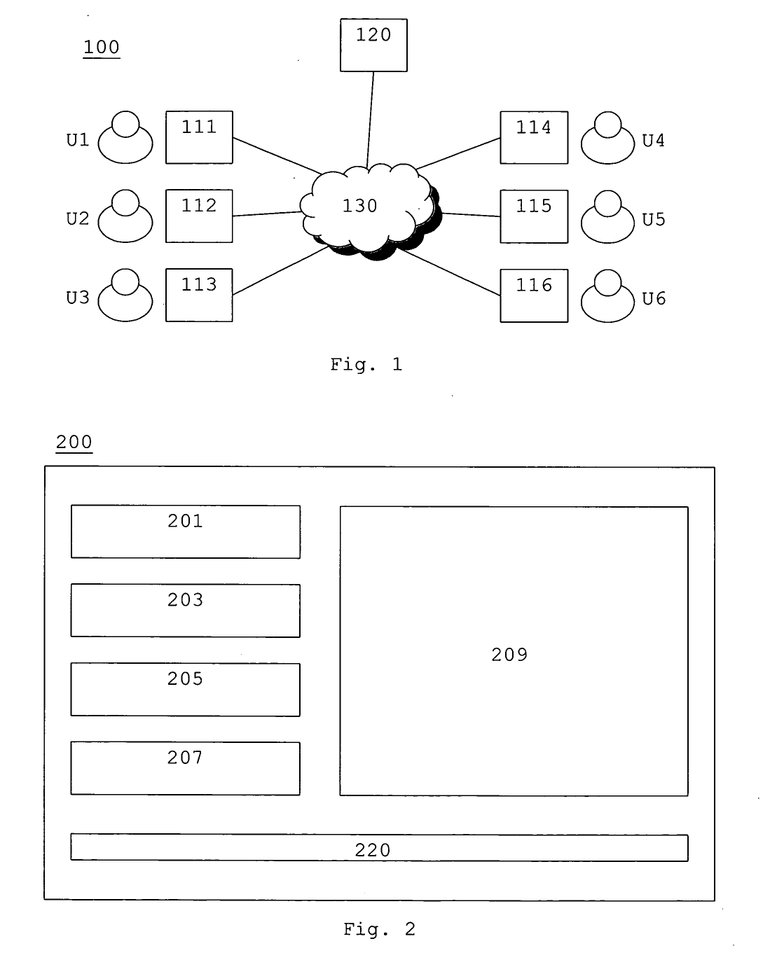

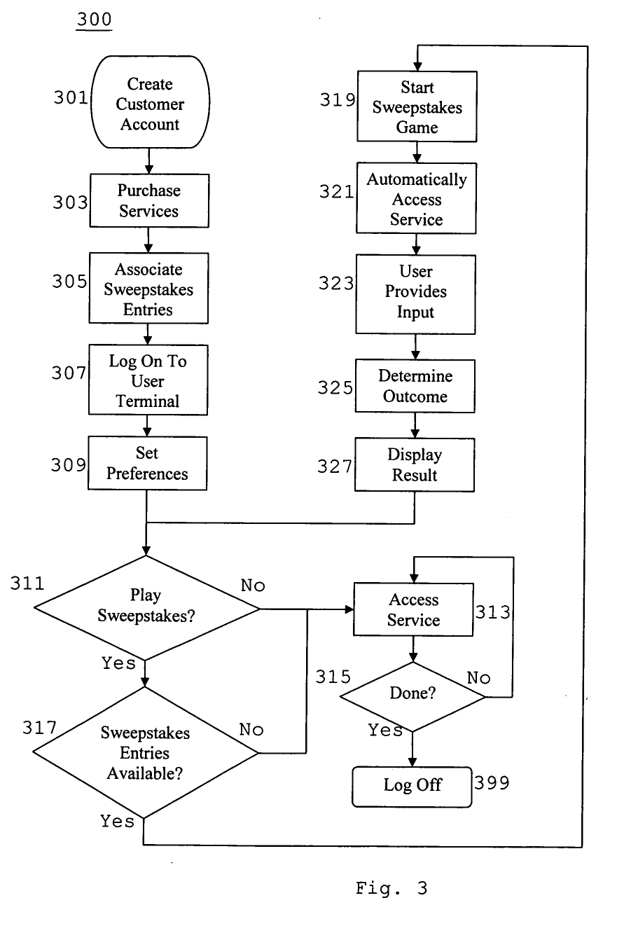

Now referring to FIG. 2, display 200 is preferably operable with an associated one of user terminals 111-116 of system 100, and is optionally further operable with network 130 and/or management terminal 120 as necessary or desired, to display an output of the sweepstakes game and to receive inputs, such as user selections or the like. As mentioned above, display 200 is preferably formed as a touch-screen display, although it will be understood by those ordinarily skilled in the art that alternative displays may be employed to carry out the functionality described herein. In addition to use in playing sweepstakes games, display 200 is preferably further operable to provide access to a service. For the purpose of example only, an embodiment involving Internet access service is described. Nonetheless, as will be understood by those skilled in the art, other types of computer or computer network based services, such as document generation services, image scanning services, database access services, communications services, or the like, may alternatively be accessed via terminal 200 in alternative embodiments.

Specifically, areas 201-209 of display 200 may be used to output a display of a selected sweepstakes game and/or to input user selections or the like, such as by touching one or areas 201-209 associated with a selected command, at least during the time when the user plays the sweepstakes game. That is to say, when the user selects not to play the sweepstakes game, the entirety of display 200, including areas 201-209, may be used to display one or more output(s) and/or to receive one or more input(s) of another feature or function of the user terminal or other component of system 100. Area 220 is preferably not associated with a sweepstakes game, even when a user is playing the sweepstakes game. Instead, area 220 is preferably associated with a computer program product operable with an associated user terminal, and/or with one or more other user terminal or management terminal 120.

The computer program product is preferably operable to automatically access the service while the user plays the sweepstakes game and to automatically display information or the like obtained from or derived from the service in area 220. That is to say, the computer program product preferably automatically accesses the Internet, such as on a continuous or periodic basis, thereby causing management computer 120 to make appropriate corresponding adjustments to one or more database field, such as by decrementing a value of a database field associated with prepaid Internet access time or by incrementing a value of a database field associated with money owed by the user. The computer program product preferably further displays such information or the like, or displays a derivation, compilation, or other product based thereon, in area 220. Such automatic access of the service is preferably performed according to at least one user-defined preference or setting, whereby the computer program product may preferably provide a user-specific display in area 220.

For example, a user, such as user U1, may select one or more desired website or Internet service from which the computer program product may locate and retrieve news headlines. Alternatively, or additionally, user U1 may select one or more topic, such as sports, business, entertainment, or the like, and the computer program product may be operable to automatically locate and retrieve news headlines from appropriate sources. As will be understood by those ordinarily skilled in the art, the computer program product may alternatively or additionally locate and retrieve other types of information, such as stock or commodity prices, streaming music and/or video, or the like, as desired by the user. Furthermore, in addition to, or in place of display area 220, the computer program product may output the retrieved content via audio speakers or the like. As will be understood by those ordinarily skilled in the art, it may be preferable for the computer program product to modify retrieved content for display in a modified form. For example, headlines, stock prices, game scores, trivia, or the like, may stream across area 220, or the display of content may be static or flashing.

In one specific example, the computer program product comprises a scrolling web feed populated with content retrieved from the Internet. The content may include, for exemplary purposes only, blog entries, news headlines, podcasts, or the like. The web feed is preferably configured as a RSS feed. The computer program product preferably displays the content of the RSS feed along the bottom of the screen. The source RSS feed(s), i.e. the feed(s) which determine(s) the content to be displayed, is(are) determined by the user. The content may optionally be saved subsequent use or consumption at a later time, and may optionally be re-formatted by the computer program product. The computer program product is preferably reconfigurable by the user, whereby different sources of content and/or different display formats or other settings may be updated, changed, or the like as desired.

In use, system 100 may be used to perform method 300. For example, a new customer may desire to purchase services. An operator or manager of system 100 may create a user account associated with the new customer at step 301. The new customer may then pre-pay for services and a record of such pre-paid services may be associated with the new customer's account at step 303. A plurality of sweepstakes entries may then be associated with the new customer's account at step 305, wherein the number of entries preferably corresponds to the value of pre-paid services purchased. The new customer may then access a user terminal to access the service and/or sweepstakes games at step 307. Once the new customer has logged on to a user terminal, the new customer may set preferences within the system at step 309, preferably including preferences for the computer program product. For example, the new customer may select from a plurality of preconfigured setting combinations. The new customer may select one or more service based function for automatic performance during sweepstakes game play, if desired, or may elect not to use the service during sweepstakes play. When the new customer has completed the setting configuration, the new customer is preferably given the option to play sweepstakes games or to access the service at step 311. If the new customer decides at step 311 to not play sweepstakes games, then the user may access the service at step 313. When the new customer decides at step 315 that the new customer is done, the new customer may log off the user terminal at step 399. If the new customer is not done at step 315 the new customer may continue to access the service at step 313. As will be understood by those ordinarily skilled in the art, the method may include additional steps as necessary or desired to accommodate the specific business implementation or business goals. For example, the system may verify that an account associated with the new user has a sufficient amount of pre-paid service and may notify the new customer when the amount of pre-paid service is depleted.

If the new customer decides at step 311 to play a sweepstakes game, the system preferably verifies that the new customer has one or more sweepstake entry associated with a respective user account at step 317. If the system determines that no sweepstakes entries are available at step 317, then the system preferably allows the new customer to access the service at step 313. If, however, the system determines that the new customer does have sweepstakes entries, the system may then start a selected sweepstakes game at step 319. Additionally, the system may automatically run the computer program product according to the preferences of the new customer at step 321. Accordingly, the computer program product may access the service and display content in area 220 of display 200. The new customer may then provide any input necessary or desired to play the sweepstakes game at step 323. The system may then determine the outcome of the sweepstakes game and display the results to the new customer at steps 325 and 327, respectively. The new customer may then be given the choice of playing additional sweepstakes games or using the service by returning to step 311.

Having thus described exemplary embodiments of the system and method of the present disclosure, it should be noted by those skilled in the art that the within disclosures are exemplary only and that various other alternatives, adaptations, and modifications may be made within the scope and spirit of the present invention. For example, and as mentioned above, while an embodiment of the system involving Internet access service is described, other embodiment involving other services are contemplated. Similarly, while certain functions of the system have been described being performed by selected components in certain ways, such as management of entry and pre-paid service or billing values by management terminal 120 using one or more database, such functions may be performed by any suitable components in any suitable way to enable the functions described herein, or their equivalent functions. Accordingly, the present invention is not limited to the specific embodiments as illustrated herein, but is only limited by the following claims.

What is claimed is at least:

1. A method for promoting a business using a promotion sweepstakes comprising the steps of:
associating at least one sweepstakes entry with a customer;
accessing a terminal of a system of the business;
playing a sweepstakes using the entry; and
accessing a service of the business via the terminal;
wherein said step of playing a sweepstakes and said step of accessing a service are performed simultaneously, and wherein said step of playing a sweepstakes is independent from said step of accessing a service.

2. The method of claim 1, wherein said steps of accessing a terminal, playing a sweepstakes, and accessing a service are performed by the customer.

3. The method of claim 1, wherein said step of associating at least one sweepstakes entry comprises associating at least one sweepstakes entry with an account, the account being associated with the customer.

4. The method of claim 1, wherein said step of associating at least one sweepstakes entry comprises associating a number of sweepstakes entries with a customer, the number being based on a value of services purchased by the customer.

5. The method of claim 1, wherein said step of accessing a terminal comprises providing identification information.

6. The method of claim 1, further comprising the step of configuring a computer program product operable with the terminal, wherein said step of accessing a service is performed by the computer program product.

7. The method of claim 1, wherein said step of accessing a service comprises the steps of locating at least one target, receiving information from the target, and providing an output to the customer.

8. The method of claim 7, wherein the output is generated based on the information.

9. The method of claim 7, wherein the output comprises a visual output provided via a display of the terminal.

10. The method of claim 9, wherein said step of playing a sweepstakes comprises playing a game and includes the step of providing a visual output via the display, the visual output of the game being provided simultaneously with output of the service.

11. The method if claim 7, wherein the target is a RSS feed.

12. The method of claim 7, wherein said step of receiving information comprises communication via a wide area network.

13. A system for providing a service and for promoting the service via a sweepstakes, said system comprising:
a terminal operable to provide access to the service and operable to provide access to the sweepstakes; and
a computer program product operable with said terminal to provide an output via said terminal during a time when a user accesses the sweepstakes.

14. The system of claim 13, wherein said terminal comprises a display, and wherein said computer program product provides said output via said display.

15. The system of claim 13, further comprising means for maintaining at least one user account, wherein access to the service and to the sweepstakes is permitted based on information associated with said at least one user account.

16. The system of claim 13, wherein said computer program product comprises a configurable setting, and wherein said computer program product is operable to provide said output according to said setting.

17. The system of claim 13, wherein said computer program product is operable to locate a target via a network and receive information from the target, and wherein said output is based on the information received from the target.

18. The system of claim 17, wherein the target comprises a RSS feed.

19. The system of claim 13, wherein the service comprises providing Internet access.

20. The system of claim 13, wherein said sweepstakes comprises a computer program product operable with said terminal to provide an output of a result of a game.
